(19) United States
(12) Patent Application Publication
(10) Pub. No.: US 2010/0156743 A1
(43) Pub. Date: Jun. 24, 2010

(54) ANTENNA DEVICE

(75) Inventors: Masahiro Yanagi, Shinagawa (JP); Shigemi Kurashima, Shinagawa (JP); Takashi Arita, Shinagawa (JP)

Correspondence Address: IPUSA, P.L.L.C, 1054 31ST STREET, N.W., Suite 400, Washington, DC, 20007, US

(73) Assignee: FUJITSU COMPONENT LIMITED

(21) Appl. No.: 12/623,619

(22) Filed: Nov. 23, 2009

(30) Foreign Application Priority Data
Dec. 24, 2008 (JP) 2008-328200

(51) Int. Cl. H01Q 1/36; H01Q 1/48; H01Q 19/10

(52) U.S. Cl. 343/846; 343/899

(57) ABSTRACT

An antenna device includes an oval-shaped element which is formed by geometrically combining a spherical portion and a conical portion so that the spherical portion is tangent to a bottom side of the conical portion. A ground plate is arranged to face a vertex of the conical portion in the oval-shaped element. A coaxial line includes an inner conductor and an outer conductor, the inner conductor being connected to the vertex of the conical portion of the oval-shaped element and the outer conductor being connected to the ground plate. A conductive reflecting plate is arranged on the ground plate to reflect a receiving radio wave or a transmitting radio wave.

### BACKGROUND OF THE INVENTION

1. Field of the Invention

This invention relates to an antenna device which is appropriate for use in a device having a function of receiving and/or transmitting radio waves.

2. Description of the Related Art

In recent years, the wireless-communications technology using UWB (ultra-wide band) attracts attention because it enables radar positioning and large transmission capacity communications. In 2002, the FCC (Federal Communications Commission) issued the rules for ultra-wide band (UWB) devices used in frequencies in the range of 3.1-10.6 GHz, and issued certification for equipment under the UWB rules.

The UWB devices perform communications by transmitting a pulse signal in the frequencies in the range of 3.1-10.6 GHz. For this reason, an antenna device used for the UWB devices requires a structure that is capable of receiving a pulse signal in the ultra-wide band frequencies.

Japanese Laid-Open Patent Publication No. 2004-129209 and “Low-VSWR, Ultra-Wide Band Antenna Which Is Non-directional In Horizontal Plane” B-1-133 by T. Taniguchi et al. (Tokyo Denki University) in 2003 from the Institute of Electronics, Information and Communications Engineers in Japan disclose an antenna device of this type. The antenna device of this type includes a ground plate and a feeding unit, and is adapted for use in the 3.1-10.6 GHz frequency band as licensed by the FCC.

FIGS. 1A and 1B illustrate the composition of each of antenna devices according to the related art. FIG. 2 illustrates the composition of each of the antenna devices according to the related art connected to a filter and a transceiver unit.

In an antenna device 10 illustrated in FIG. 1A, a feeding unit 12 which is in an inverted cone shape is arranged on a ground plate 11. The cone which constitutes the feeding unit 12 is placed to be at an angle T to the surface of the ground plate 11. By adjusting the angle T at which the feeding unit 12 is placed, a desired characteristic of the antenna device is obtained.

In an antenna device 20 illustrated in FIG. 1B, an oval-shaped feeding unit 22 which is formed by combining a cone 22a and a sphere 22b inscribed in the cone 22a is arranged on a ground plate 11.

As illustrated in FIG. 2, each of the antenna devices 10 and 20 is arranged so that the feeding unit 12 is connected to a filter 31 and the filter 31 is connected to a transceiver unit 32. The filter 31 functions to extract the signal component of a predetermined frequency band from among the radio waves received at the feeding unit 12. The signal component extracted by the filter 31 is supplied to the transceiver unit 32. The transceiver unit 32 performs signal processing which corresponds to preprocessing of the received radio waves or post-processing of the received radio waves.

In the antenna device according to the related art in which the oval-shaped feeding unit is connected to the ground plate, the antenna device is non-directional in a horizontal plane. The antenna device according to the related art receives the radio waves which are forwarded from all the directions, and transmits the radio waves to all the directions. For this reason, radio waves containing noise, other than the radio wave that is to be received, are likely to be received by the antenna device according to the related art. The antenna device according to the related art has the problem that the received signal contains noise components at a high ratio.

Moreover, the antenna device according to the related art is non-directional in a horizontal plane, and it is difficult for the antenna device to suitably select a radio wave to be received from among the radio waves which are forwarded from all the directions.

### SUMMARY OF THE INVENTION

In one aspect of the invention, the present disclosure provides an antenna device including an oval-shaped element which is arranged by giving directivity to enable reception of only a radio wave in a specific direction and to improve the sensitivity of the antenna device.

In an embodiment of the invention which solves or reduces one or more of the above-mentioned problems, the present disclosure provides an antenna device including: an oval-shaped element formed by geometrically combining a spherical portion and a conical portion so that the spherical portion is tangent to a bottom side of the conical portion; a ground plate arranged to face a vertex of the conical portion in the oval-shaped element; a coaxial line including an inner conductor and an outer conductor, the inner conductor being connected to the vertex of the conical portion of the oval-shaped element and the outer conductor being connected to the ground plate; and a conductive reflecting plate arranged on the ground plate to reflect a receiving radio wave or a transmitting radio wave.

In an embodiment of the invention which solves or reduces one or more of the above-mentioned problems, the present disclosure provides an antenna device including: an oval-shaped element formed by geometrically combining a spherical portion and a conical portion so that the spherical portion is tangent to a bottom side of the conical portion; a ground plate arranged to face a vertex of the conical portion of the oval-shaped element; and a coaxial line including an inner conductor and an outer conductor, the inner conductor being connected to the vertex of the conical portion of the oval-shaped element and the outer conductor being connected to the ground plate, wherein a portion of the ground plate in a vicinity of the oval-shaped element is bent toward the oval-shaped element and the bent portion of the ground plate functions to reflect a receiving radio wave or a transmitting radio wave.

### BRIEF DESCRIPTION OF THE DRAWINGS

FIGS. 1A and 1B are diagrams illustrating the composition of each of antenna devices according to the related art.

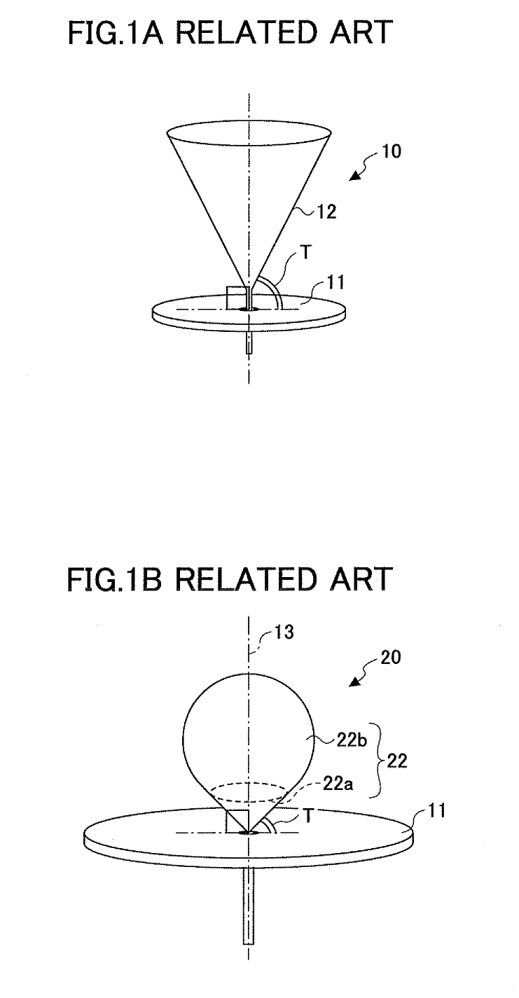

FIG. 2 is a diagram illustrating the composition of each of the antenna devices according to the related art connected to a filter and a transceiver unit.

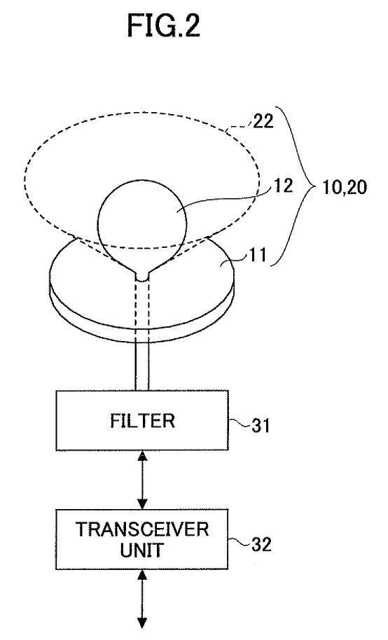

FIGS. 3A and 3B are diagrams illustrating the composition of an antenna device of an embodiment of the invention.

FIG. 4 is a cross-sectional view of the antenna device of the present embodiment.

FIGS. 5A and 5B are diagrams illustrating the composition of a modification of the antenna device of the present embodiment.

FIG. 6 is a diagram illustrating the composition of an antenna device of another embodiment of the invention.

### DETAILED DESCRIPTION OF THE PREFERRED EMBODIMENTS

A description will be given of embodiments of the invention with reference to the drawings.

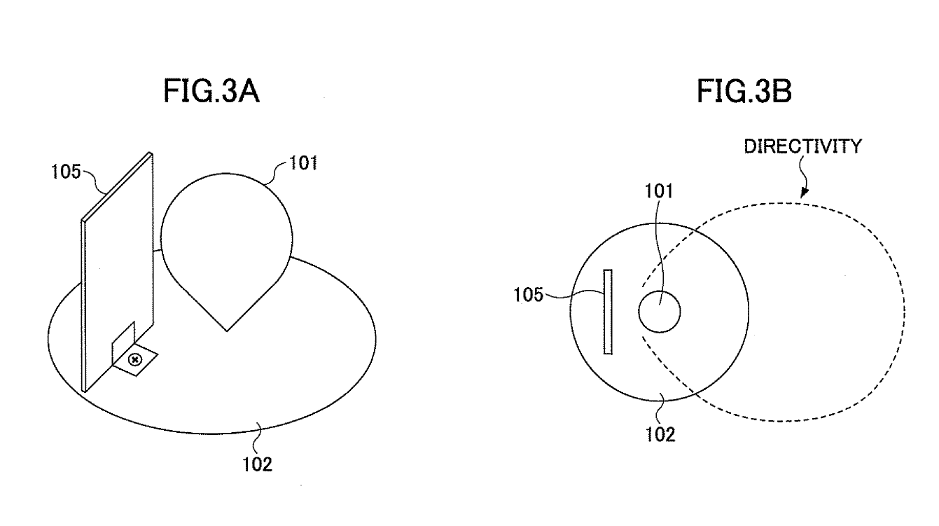

An antenna device of an embodiment of the invention has the composition in which a metal plate is arranged in a vicinity of an oval-shaped element on a ground plate. FIGS. 3A and 3B illustrate the composition of the antenna device of this embodiment. FIG. 3A is a perspective view of the antenna device of this embodiment. FIG. 3B is a top view of the antenna device of this embodiment.

As illustrated in FIGS. 3A and 3B, in the antenna device of this embodiment, an oval-shaped element 101 is a feeding unit, and the oval-shaped element 101 is formed by geometrically combining a spherical portion and a conical portion so that the spherical portion is tangent to a bottom side of the conical portion. The oval-shaped element 101 is connected at a vertex of the conical portion thereof to a ground plate 102. A reflecting plate 105 is arranged on the ground plate 102 in a vicinity of the oval-shaped element 101. The ground plate 102 and the reflecting plate 105 are made of a metallic material.

By arranging the antenna device in this composition, a directivity of radio waves is given to the antenna device as illustrated in FIG. 3B.

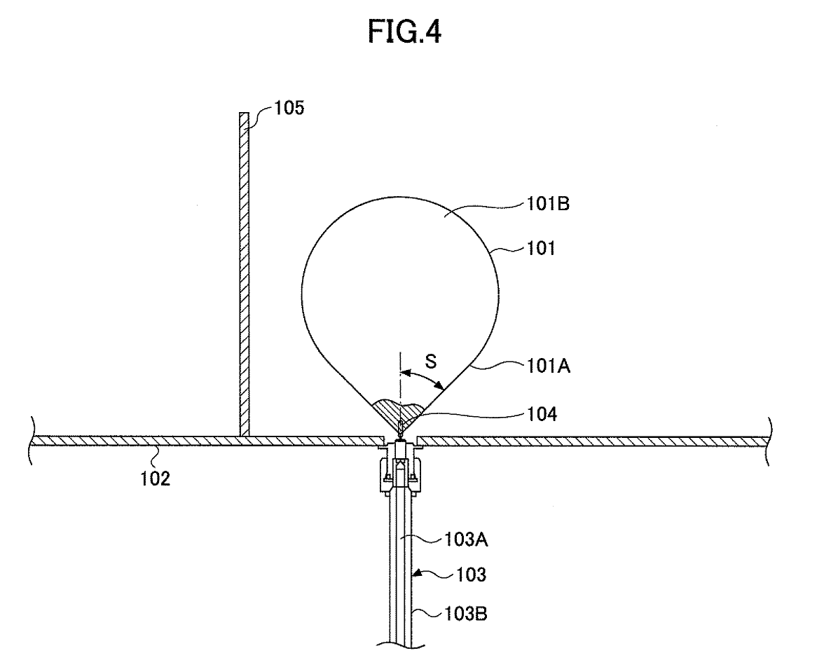

FIG. 4 is a cross-sectional view of the antenna device of the present embodiment. The ground plate 102 and the oval-shaped element 101 in this embodiment will be described with reference to FIG. 4.

The oval-shaped element 101 is formed by geometrically combining a conical portion 101A and a spherical portion 101B so that the spherical portion 101B is tangent to a bottom side of the conical portion 101A. The conical portion 101A is arranged to have a predetermined half vertical angle S as illustrated in FIG. 4.

The oval-shaped element 101 is attached at the vertex of the conical portion 101A to the ground plate 102 at right angles. Specifically, a joint 104 is formed on the ground plate 102, a portion of the conical portion 101A corresponding to the joint 104 is formed at the vertex of the conical portion 101A, and the oval-shaped element 101 is attached to the ground plate 102 by bonding the joint 104 and the portion of the conical portion 101A together.

Each of the oval-shaped element 101 and the ground plate 102 is made of a conductive metallic material, such as aluminum.

In the antenna device of this embodiment, a coaxial cable 103 is arranged. An outer conductor 103B of the coaxial cable 103 is electrically connected to the ground plate 102, and an inner conductor 103A of the coaxial cable 103 is electrically connected to the oval-shaped element 101 via the joint 104. The ground plate 102 is grounded via the outer conductor 103E of the coaxial cable 103.

Furthermore, in the antenna device of this embodiment, a reflecting plate 105 is arranged so that the reflecting plate 105 is perpendicular to the ground plate 102. The reflecting plate 105 has a function of reflecting receiving radio waves or transmitting radio waves which are forwarded to the reflecting plate 105. Specifically, the reflecting plate 105 reflects the receiving or transmitting radio waves which are forwarded to the reflecting plate 105, and directs the radio waves to the oval-shaped element 101. For this purpose, the reflecting plate 105 is made of a conductive material. By the use of the reflecting plate 105, the intensity of radio waves received by the antenna device including the oval-shaped element 101 can be increased.

The antenna device of this embodiment is arranged with the reflecting plate 105, and it is possible for the antenna device of this embodiment to receive only a radio wave in a specific direction. That is, the directivity can be given to the antenna device of this embodiment.

The reflecting plate 105 is arranged to be perpendicular to the ground plate 102, and it is possible to efficiently increase the intensity of radio waves received by the antenna device including the oval-shaped element 101, without cutting off the radio wave to be received.

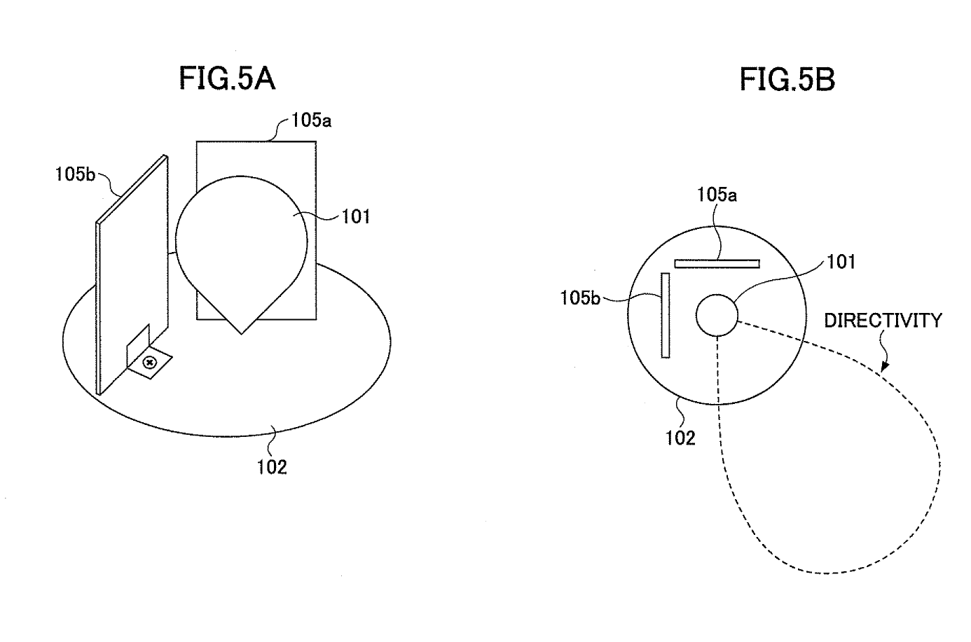

FIGS. 5A and 5B illustrate the composition of a modification of the antenna device of this embodiment. If two or more reflecting plates are arranged in the antenna device as illustrated in FIGS. 5A and 5B, the advantageous features of the antenna device of this embodiment can be further enhanced. FIG. 5A is a perspective view of the antenna device of this modification. FIG. 5B is a top view of the antenna device of this modification.

In the antenna device illustrated in FIGS. 5A and 5B, reflecting plates 105a and 105b are arranged on the ground plate 102 in a vicinity of the oval-shaped element 101. The reflecting plates 105a and 105b can reflect the receiving or transmitting radio waves and direct the radio waves to the oval-shaped element 101 without cutting off the radio wave to be received.

The antenna device of this modification is arranged with two or more reflecting plates, and the directivity of the antenna device can be improved further and the intensity of the received radio waves can be increased.

In the antenna device of this embodiment, the two reflecting plates are arranged as illustrated in FIGS. 5A and 5B. Alternatively, three or more reflecting plates may be arranged in the antenna device.

Next, a description will be given of an antenna device of another embodiment of the invention. The antenna device of this embodiment has the composition in which a reflecting plate is formed by bending a ground plate.

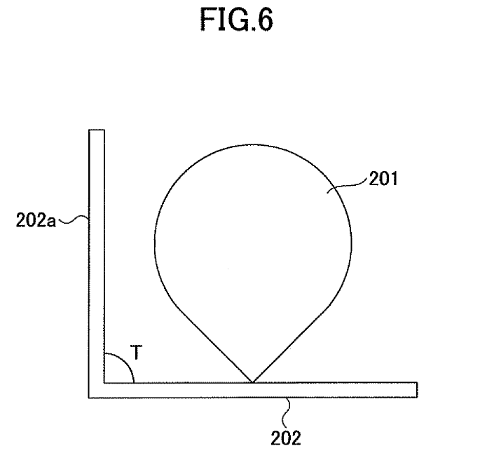

FIG. 6 illustrates the composition of the antenna device of this embodiment. FIG. 6 is a side view of the antenna device of this embodiment.

In the antenna device of this embodiment, an oval-shaped element 201 is attached to a main part of a ground plate 202, and a reflecting plate 202a is formed by bending a portion of the main part of the ground plate 202 located in a vicinity of the oval-shaped element 201.

It is necessary that the reflecting plate 202a has a function of reflecting radio waves. This function of the reflecting plate 202a can be easily obtained because the reflecting plate 202a in this embodiment is made of a material that is the same as the material of the main part of the ground plate 202. For the antenna device of this embodiment, it is not necessary to prepare a reflecting plate which is separate from other component parts. Thus, the manufacturing cost can be reduced.

In the above embodiment, the reflecting plate 202a is formed by bending the main part of the ground plate 202. In this case, it is preferred to set the bending angle T (as illustrated in FIG. 6) between the reflecting plate 202a and the remaining portion of the ground plate 202 to 90 degrees. By setting the bending angle T to 90 degrees relative to the remaining portion of the ground plate 202, the intensity of radio waves received by the antenna device including the oval-shaped element 101 can be increased efficiently, without cutting off the radio wave to be received.

According to at least one embodiment of the invention, it is possible to provide an antenna device including an oval-shaped element which is arranged to enable reception of only a radio wave in a specific direction and to improve the sensitivity of the antenna device.

The present invention is not limited to the specifically disclosed embodiments, and variations and modifications may be made without departing from the scope of the present invention.

The present application is based on Japanese patent application No. 2008-328200, filed on Dec. 24, 2008, the entire contents of which are incorporated herein by reference in their entirety.

What is claimed is:

1. An antenna device comprising:
an oval-shaped element formed by geometrically combining a spherical portion and a conical portion so that the spherical portion is tangent to a bottom side of the conical portion;
a ground plate arranged to face a vertex of the conical portion in the oval-shaped element;
a coaxial line including an inner conductor and an outer conductor, the inner conductor being connected to the vertex of the conical portion of the oval-shaped element and the outer conductor being connected to the ground plate; and
a conductive reflecting plate arranged on the ground plate to reflect a receiving radio wave or a transmitting radio wave.

2. The antenna device according to claim 1, wherein the reflecting plate is perpendicular to the ground plate.

3. The antenna device according to claim 1, wherein the antenna device includes a plurality of said reflecting plates.

4. An antenna device comprising:
an oval-shaped element formed by geometrically combining a spherical portion and a conical portion so that the spherical portion is tangent to a bottom side of the conical portion;
a ground plate arranged to face a vertex of the conical portion of the oval-shaped element; and
a coaxial line including an inner conductor and an outer conductor, the inner conductor being connected to the vertex of the conical portion of the oval-shaped element and the outer conductor being connected to the ground plate,
wherein a portion of the ground plate in a vicinity of the oval-shaped element is bent toward the oval-shaped element and the bent portion of the ground plate functions to reflect a receiving radio wave or a transmitting radio wave.

5. The antenna device according to claim 4, wherein a bending angle at which the portion of the ground plate is bent is set to 90 degrees relative to a remaining portion of the ground plate.
